(19) United States
(12) Patent Application Publication
(10) Pub. No.: US 2026/0254401 A1
(43) Pub. Date: Aug. 27, 2026

(54) A SOLAR PANEL SUPPORT

(71) Applicant: MODULAR SOLAR TECHNOLOGIES LTD, Hope Valley (GB)

(72) Inventor: Stephen DEMPSEY, Hope Valley (GB)

(21) Appl. No.: 18/855,805

(22) PCT Filed: Apr. 6, 2023
(86) PCT No.: PCT/GB2023/050922

§ 371 Date: Oct. 10, 2024

(30) Foreign Application Priority Data
Apr. 12, 2022 (GB) 2205415.9

(51) Int. Cl. H02S 20/30; H02S 30/20; H02S 40/32; H02S 40/36

(52) U.S. Cl. CPC H02S 20/30; H02S 30/20; H02S 40/32; H02S 40/36

(57) ABSTRACT

A solar panel support, the solar panel support comprising: a hollow base; an inclinable panel, configured to be attached to the solar panel, rotatably connected to the base by at least one hinge to enable the inclinable panel to be inclined at an angle to the base; and coupling means configured to couple the solar panel support to a second solar panel support.

### TECHNICAL FIELD

Examples of the disclosure relate to a solar panel support. Some relate to a solar panel support that is configured for supporting a solar panel on a body of water or on land.

### BACKGROUND

Photovoltaic panels for electrical power generation are becoming increasingly commonplace, with large arrays of photovoltaic panels being installed. However, groundworks for the installation of the arrays of photovoltaic panels can be significant, as can the area of land occupied by these arrays.

### SUMMARY OF THE INVENTION

According to various, but not necessarily all, embodiments there is provided a solar panel support, the solar panel support comprising: a hollow base; an inclinable panel, configured to be attached to the solar panel, rotatably connected to the base by at least one hinge to enable the inclinable panel to be inclined at an angle to the base; and coupling means configured to couple the solar panel support to a second solar panel support.

The coupling means may comprise: a male connector and a female connector sized for insertion of a male connector within a female connector in an insertion direction, wherein the male connector and the female connector are at opposing lateral sides of the base and the insertion directions are substantially orthogonal to the at least one hinge; and a male connector and a female connector sized for insertion of a male connector with a female connector in an insertion direction, wherein the male connector and the female connector are at opposing lateral sides of the inclinable panel and the insertion directions are substantially orthogonal to the at least one hinge.

The female connector of the base may be configured to receive a male connector of a second base of a second solar panel support; and the female connector of the inclinable panel may be configured to receive a male connector of a second inclinable panel of a second support.

The base may comprise at least one tether attachment.

The base may comprise at least one gas-filled void.

The angle of the inclinable panel to the base may be controllable by an adjustment means.

The base and the inclinable panel may be substantially cuboidal.

The inclinable panel may comprise electrical connection means to electrically connect the solar panel supported by the solar panel support to an electrical network.

The solar panels comprising the electrical network may be electrically connected in series or parallel.

The inclinable panel may comprise an electrical inverter configured to convert direct current output from the solar panel to alternating current.

The hollow base may define at least one chamber that is configured to receive and retain ballast.

The chamber may comprise an aperture that is configured to receive the ballast. The chamber may be liquid tight such that the chamber is configured to retain liquid ballast. The chamber may comprise at least one aperture configured to exhaust the ballast from the chamber.

The aperture configured to receive the ballast may be different from the aperture configured to exhaust the ballast from the chamber.

The solar panel support may comprise a connector configured to connect the at least one aperture configured to exhaust the fluid from the chamber to an aperture in the base of a second solar panel support.

The solar panel supported by the solar panel support may be a solar film and the solar panel support may be configured to provide a first configuration in which a light receiving surface of the solar film is substantially flat and a second configuration in which the light receiving surface of the solar film is substantially arcuate or substantially bent.

The inclinable panel may comprise an actuator configured to cause the solar panel support to transition between the first and second configurations.

The solar film may be at least partly fastened to the inclinable panel by at least one fastener at or close to the periphery of the inclinable panel, and the at least one fastener and the actuator may be configured such that, when the actuator causes the solar panel support to transition between the first configuration and the second configuration, the solar film remains fastened to the inclinable panel at or close to the periphery of the inclinable panel.

The actuator may be configured to push a portion of the solar film to transition the solar panel support to transition from the first configuration and the second configurations.

According to various, but not necessarily all, embodiments there is provided a system, comprising a first solar panel support that includes a male connector and a female connector as described above in one or more of the preceding paragraphs, connected to a second solar panel support that includes a male connector and a female connector as described above in one or more of the preceding paragraphs.

According to various, but not necessarily all, embodiments there is provided a method for locking adjacent solar panel supports, the method comprising: aligning a base and an inclinable panel of a first solar panel support to be coplanar; aligning a base and an inclinable panel of a second solar panel support to be coplanar; receiving a male connector of the base of the first solar panel support within a female connector of the base of the second solar panel support and receiving a male connector of the inclinable panel of the first solar panel support within a female connector of the inclinable panel of the second solar panel support; and inclining the inclinable panels of the first and second solar panel supports to the bases of the first and second solar panel supports.

According to various but not necessarily all embodiments, there is provided a solar panel support. The solar panel support comprises a base panel and an inclinable panel. The inclinable panel is inclinable at an angle to the base panel. The inclinable panel is configured to be attached to the solar panel. The base panel and inclinable panel are rotatably connected by at least one hinge. The base panel is a float and is configured to float the support on a body of water.

The base panel may comprise a male connector and a female connector sized for insertion of a male connector within a female connector in an insertion direction. The male connector and the female connector may be at opposing lateral sides of the base panel. The insertion directions may be substantially orthogonal to the at least one hinge.

The inclinable panel may comprise a male connector and a female connector sized for insertion of a male connector with a female connector in an insertion direction. The male connector and the female connector may be at opposing lateral sides of the inclinable panel. The insertion directions may be substantially orthogonal to the at least one hinge.

The female connector of the base panel may be configured to receive a male connector of a second base panel of a second support.

The female connector of the inclinable panel may be configured to receive a male connector of a second inclinable panel of a second support.

The base panel may comprise at least one tether attachment.

The base panel may comprise at least one gas-filled void.

The angle of the inclinable panel to the base panel may be controllable by an adjustment means.

The base panel and the inclinable panel may be substantially cuboid.

The inclinable panel may comprise electrical connection means to electrically connect the solar panel supported by the solar panel support to an electrical network.

Solar panels comprising the electrical network may be electrically connected in series or parallel.

According to various, but not necessarily all embodiments, there is provided a system, comprising a first solar panel support, connected to a second solar panel support.

According to various, but not necessarily all embodiments, there is provided a method for locking adjacent solar panel supports. The method comprises aligning a base panel and an inclinable panel of a first solar panel support 1 to be coplanar; aligning a base panel and an inclinable panel of a second support to be coplanar; receiving a male connector of the base panel of the first support within a female connector of the base panel of the second support and receiving a male connector of the inclinable panel of the first support within a female connector of the inclinable panel of the second support; and inclining the inclinable panels of the first and second supports to the base panels of the first and second supports.

Within the scope of this application, it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates a three-dimensional view of an example of the solar panel support;

FIG. 2 illustrates a side view of an example of the solar panel support;

FIG. 3A illustrates a plan view of an example of the base panel of the solar panel support;

FIG. 3B illustrates a plan view of an example of the inclinable panel of the solar panel support;

FIG. 3C illustrates a three-dimensional view of a pair of coupled solar panel supports;

FIG. 4A illustrates an exemplary illustration of electrical connections of the solar panel support;

FIG. 4B illustrates a second exemplary illustration of electrical connections of the solar panel support;

FIG. 5A illustrates a cross-sectional front view of an example of a base panel of the solar panel support;

FIG. 5B illustrates a cross-sectional front view of an example of a pair of base panels of the solar panel support;

FIG. 6A illustrates a plan view of an example of the solar panel support in a first configuration; and

FIG. 6B illustrates a plan view of an example of the solar panel support in a second configuration.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

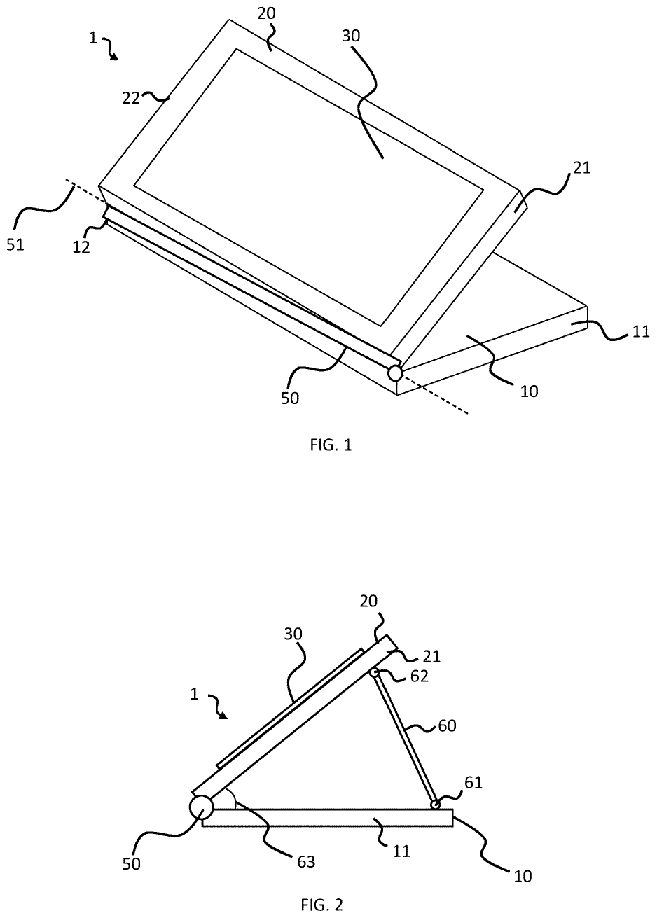

As is illustrated by FIG. 1, the solar panel support 1 comprises a base 10 and an inclinable panel 20. In this example, the base 10 may be a base panel 10, but in other examples the base need not be a panel and could be shaped differently than that shown in the figures.

The base panel 10 and the inclinable panel 20 may be substantially cuboidal in shape, the base panel 10 and inclinable panel 20 each having a length, a breadth and a height/thickness. A thickness of the base panel 10 may be less than the length and/or breadth of the base panel 10.

A surface defined by the length and breadth of the base panel 10 may be planar.

A surface defined by the breadth and height of base panel 10 may be substantially planar. As shown in FIG. 1, the base panel 10 has two such surfaces, at opposite ends of the base panel 10. These surfaces are a first base panel side 11 and a second base panel side 12. The first and second base panel sides 11, 12 are opposing lateral sides of the base panel 10. The second base panel side 12 is opposite the first base panel side 11. The second base panel side 12 is substantially parallel to the first base panel side 11.

A thickness of the inclinable panel 20 may be less than the length and/or breadth of the inclinable panel 20.

A surface defined by the length and breadth of the inclinable panel 20 may be planar.

A surface defined by the breadth and height of the inclinable panel 20 may be substantially planar. As shown in FIG. 1, the inclinable panel 20 has two such surfaces, at opposite ends of the inclinable panel 20. These surfaces are a first inclinable panel side 21 and a second inclinable panel side 22. The first and second inclinable panel sides 21, 22 are opposing lateral sides of the inclinable panel 20. The second inclinable panel side 22 is opposite the first base panel side 21. The second inclinable panel side 22 is substantially parallel to the first inclinable panel side 21.

The base panel 10 and the inclinable panel 20 may be substantially the same. For example, the base panel 10 and inclinable panel 20 may have substantially the same shape and/or dimensions. The base panel 10 and the inclinable panel 20 being substantially the same provides a benefit of being able to replace either of the base panel 10 or inclinable panel 20 with only a single spare part (i.e., the single spare part is suitable for replacing the base panel 10 and the inclinable panel 20). This also reduces the tooling (e.g., moulds) required for producing base panels 10 and inclinable panels 20.

For example, the length of the base panel 10 and the inclinable panel 20 may be approximately 2 m; the width of the base panel 10 and the inclinable panel 20 may be approximately 1 m; the thickness of the base panel 10 and the inclinable panel 20 may be in a range of 0.01 m to 0.2 m.

Alternatively, the base panel 10 and the inclinable panel 20 may be substantially different from one another. For example, the base panel 10 and the inclinable panel 20 may have different dimensions. For example, in embodiments in which the support 1 is configured to float on a body of water, the thickness of the base panel 10 may be greater than the thickness of the inclinable panel. The thickness of the base panel 10 may be increased to increase buoyancy of the support 1, due to increasing upthrust of the base panel.

As shown in FIG. 1, the base panel 10 and the inclinable panel 20 may be rotatably connected by at least one hinge 50. An axis 51 of the at least one hinge 50, about which rotation of the inclinable panel 20 relative to the base panel 10 may occur, may be aligned with the length of the base panel 10 and the length of the inclinable panel 20. The axis 51 of the at least one hinge 50 is therefore substantially perpendicular to the first base panel side 11, the second base panel side 12, the first inclinable panel side 21 and the second inclinable panel side 22.

The at least one hinge 50 may comprise a first leave, a second leave, a hinge knuckle and a pin. In some but not necessarily all embodiments, the at least one hinge 50 may be separate to the base panel 10 and/or the inclinable panel 20, and may be attached to the base panel 10 and/or the inclinable panel 20 by mechanical fixings such as screws, rivets and/or clips.

In some but not necessarily all embodiments, the at least one hinge 50 may be attached to the base panel 10 and/or the inclinable panel 20 by an adhesive.

In some but not necessarily all embodiments, at least one component (for example, the first leave, the second leave) of the at least one hinge 50 may be integral with the base panel 10 and/or the inclinable panel 20. For example, in embodiments in which either of the base panel 10 or the inclinable panel 20 is moulded, the first leave and/or second leave may be integral with the support 10, 20. In these embodiments, the first leave and/or second leave may be formed by the moulding process.

The axis 51 of the at least one hinge 50 may be at an edge of the inclinable panel 20, but away from an edge of the at least one base panel 10. This may be desirable in embodiments in which the solar panel support is floating on a body of water. This is because it may be desirable to align the centre of buoyancy and centre of gravity of the solar panel support 1.

The inclinable panel 20 may be configured to be attached to the solar panel 30. FIG. 2 provides a side elevation of the solar panel support 1. It illustrates a solar panel 30 attached to the inclinable panel 20 of the support 1. In the example of FIG. 2, the solar panel 30 is attached to a planar surface of the inclinable panel 20, and is supported by the inclinable panel 20 of the support 1.

The solar panel 30 may be a rigid solar panel 30. Alternatively, the solar panel 30 may be a deformable solar panel 30 (e.g., a solar film). The deformable solar panel 30 may be deformable such that it can be bent and/or shaped to form an arc.

As is illustrated in FIG. 2, the angle of the inclinable panel 20 to the base panel 10 may be controllable by an adjustment means 60. The base panel 10 and inclinable panel 20 may be connected by the adjustment means 60. The adjustment means 60 may be adjusted manually by a user, or automatically. The adjustment means 60 may be provided such that the inclination of the solar panel 30, supported by the solar panel support 1, may be adjusted to compensate for the elevation of the sun above the horizon. During testing, the inventor has found that adjusting the inclination of the solar panel 30 to compensate of the elevation of the sun above the horizon increases the energy output of the solar panel 30 by around 15%.

As shown in FIG. 2, the adjustment means 60 may be rotatably connected at a first end 61 to the base panel 10, and at a second end 62 to the inclinable panel 20. The adjustment means 60 may be adjusted by adjusting a length of the adjustment means 60 to adjust the distance between the first and second ends 61, 62. Adjusting the length of the adjustment means 60 changes the angle of inclination 63 of the inclinable panel 20 relative to the base panel 10. In other words, adjusting the length of the adjustment means 60 adjusts the angle of inclination 63 subtended between the inclinable panel 20 and the base panel 10. Increasing the length of the adjustment means 60 increases the angle of inclination 63 of the inclinable panel relative to the base panel 10. Decreasing the length of the adjustment means 60 decreases the angle of inclination 63 of the inclinable panel 20 relative to the base panel 10.

The adjustment means 60 may be by any suitable means. For example, the adjustment means may comprise one or more of a lead screw, a hydraulic piston and a pneumatic piston.

The adjustment means 60 may comprise feedback means (not shown). The feedback means may comprise at least one of a position sensor and an angle sensor.

The position sensor may determine the separation/distance between the first end 61 and the second end 62. Position sensing may be done by a user or automatically. For example, a ruler may be aligned parallel with an axis of the adjustment means 60, in which the axis of the adjustment means passes through the first end 61 and the second end 62. The ruler may be read by a user to determine the separation between the first end 61 and the second end 62.

Additionally or alternatively, position sensing by the position sensor may comprise measuring an electrical resistance of the position sensor, in which the resistance of the sensor changes with the length of the sensor and the length of the position sensor changes with the length of the adjustment means 60.

Additionally or alternatively, position sensing by the position sensor may comprise laser-based distance measurement. Laser-based distance measurement may comprise determination of a distance of a target associated with either of the inclinable panel 20 or base panel 10 from a laser-based distance measuring device associated with the other of the inclinable panel 20 or base panel 10 (i.e., the target is connected to one of the inclinable panel 20 or the base panel 10 while the laser-based distance measuring device is connected to the other of the inclinable panel 20 or base panel 10).

Additionally or alternatively, position sensing may be determined indirectly, by for example, measuring the number of rotations of a lead screw from a datum and multiplying the number of rotations by a thread pitch of the lead screw. This determines a length offset to add to a datum length of the adjustment means to determine the length of the adjustment means 60, and hence, the separation between the first end 61 and the second end 62.

The angle sensor may comprise a protractor and/or a rotational potentiometer. The protractor may be configured to measure the angle of inclination 63 of the inclinable panel 20 relative to the base panel 10. The protractor may be read manually by a user. The electrical resistance of the rotational potentiometer may vary with the angle of inclination 63.

In embodiments in which position sensing or angle sensing is automatic, the adjustment means 60 may be controlled automatically. For example, the length of the adjustment means 60 may be adjusted by an electrical machine such as a stepper motor, controlled by a control unit (not shown). The control unit may control the length of the adjustment means 60 based at least in part on a time of day and/or day of the year and/or latitude at the location of the solar panel support 1. The time of day and/or day of the year may be provided to the control unit by a timer within the control unit. The latitude may be provided to the control unit by a user input, in which the latitude corresponds to the latitude of the location of the support. In these embodiments, the control unit provides a set-point for the length of the adjustment means 60, with closed loop feedback of the actual length of the adjustment means 60 (separation between first end 61 and second end 62) used to drive the adjustment means 60 to the setpoint.

In other embodiments, the control unit may provide a set point for the angle of inclination 63 of the inclinable panel 20 relative to the base panel 10. In these embodiments, closed loop feedback of the actual angle of inclination 63 of the inclinable panel 20 relative to the base panel 10 may be derived from an output of the rotational potentiometer, and used to drive the adjustment means 60 to the setpoint.

The control unit may be configured to receive a control signal (not shown). The control signal may be provided to the control unit by any suitable means. For example, the control signal may be provided to the control unit by a wired connection, or may be provided to the control unit by a wireless connection (for example, Bluetooth or Wifi).

In embodiments in which the adjustment means 60 comprises an electrical machine, the electrical energy provided to the electrical machine may be provided by the solar panel 30 supported by the solar panel support 1. In some but not necessarily all embodiments, the electrical energy provided to the electrical machine may be provided by an electrical battery. The electrical battery may be charged by the solar panel 30 supported by the solar panel support 1.

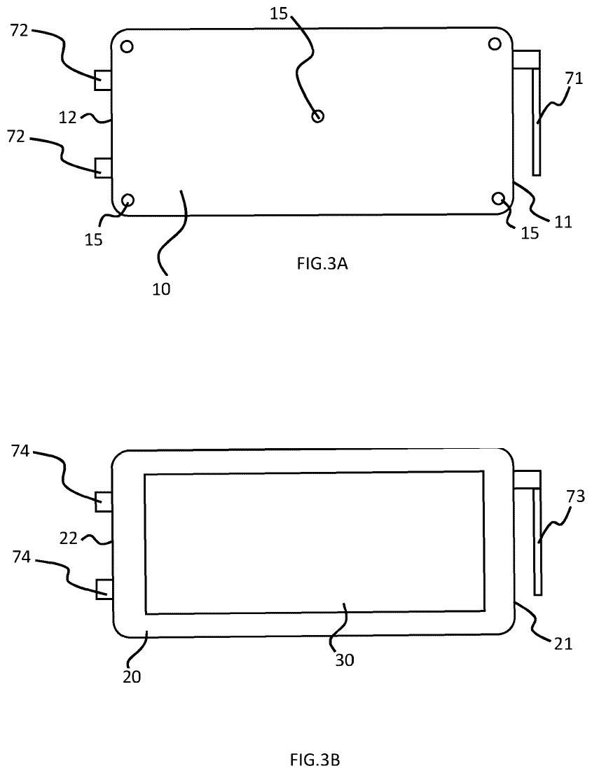

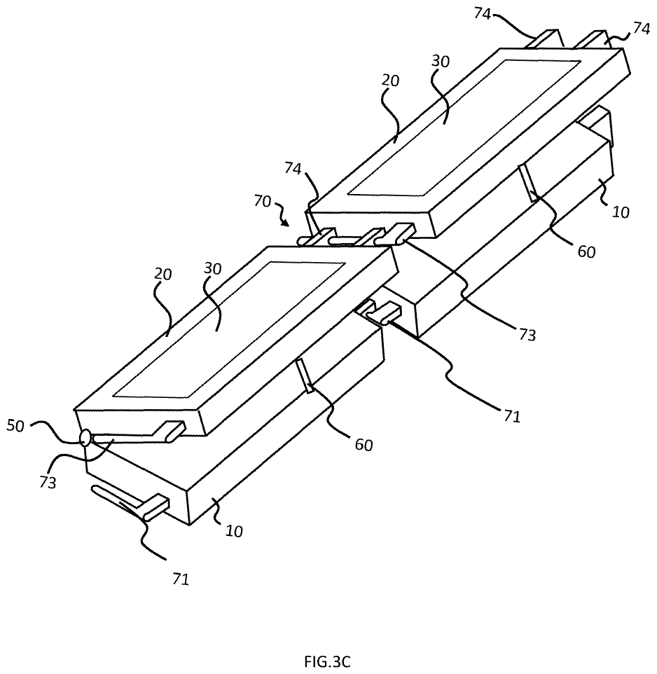

The base panel 10 may comprise one or more tether points 15. As is illustrated in FIG. 3A, the base panel 10 may comprise a plurality of tether points 15. Tether points 15 may be provided proximal to a corner of the base panel and/or proximal to a centre of the base panel.

The tether points 15 are configured to mount the solar panel support 1 at a fixed location, for example, to mount it to the ground or anchor it on a body of water (for example, to a bed of the body of water). A body of water may comprise a lake, a river or an area of water close to a coastline.

Although a plurality of tether points 15 may be provided, a subset of the plurality of tether points 15 may mount the base panel 10 to the ground or anchor the base panel 10 on a body of water. This is because by coupling adjacent solar panel supports 1 to each other, as is now disclosed, the number of required tether points 15 per ground/base panel 10 may be reduced. This eases installation.

The base panel 10 and/or inclinable panel 20 may be provided with coupling means 70. The coupling means 70 may couple a first base panel 10 to an adjacent second base panel 10 and/or couple a first inclinable panel 20 to an adjacent second inclinable panel 20.

The coupling means may be configured to couple a first solar panel support 1 to an adjacent/second solar panel support 1. Similarly, the second solar panel support 1 may be coupled to a third solar panel support 1 that is adjacent to the second solar panel support 1. Each of the first, second and third solar supports 1 may be as described herein. They might be the same as each other, or have different features from one another. It should be understood that any number of solar panel supports 1 can be coupled in this manner.

Coupling multiple solar panel supports 1 may form an array of supports for a solar panel. This may be beneficial when tethering the supports 1 to the ground, or a body of water. This is because the coupling means 70 reduces movement between adjacent supports and reduces the number of tethering means/tether attachments (tethers) that are required to locate the support 1 to a location.

For example, when coupled to form an array of supports 1, a single tether may be used per support 1. This is because the tether locates the support 1, while rotation of the support 1 is reduced by reaction forces with adjacent supports′ in the array of supports 1. This may be desirable because the amount of groundwork, such as preparation of foundations, may be decreased (when the array is installed on the ground), or the amount of anchoring may be decreased if the array is installed on a body of water.

In some embodiments, an array of supports 1 may comprise up to thirty coupled supports 1. In other embodiments, an array of supports 1 may comprise more than thirty coupled supports 1.

The coupling means 70 may be a mechanical/physical coupling means. The coupling means 70 may be any suitable means for mechanically/physically coupling a first solar panel support 1 to a second solar panel support 1. The coupling means 70 may be any suitable means for coupling a first solar panel support 1 to a second solar panel support 1 such that the solar panel supports 1 remain coupled when a force (e.g., push, pull, etc.) is applied to either or both the solar panel supports 1.

The coupling means 70 may comprise at least one cable tie. As shown best in FIGS. 3A-3C, the coupling means 70 may comprise a male connector 71 and a female connector 72. Each base panel 10 may comprise at least one male connector 71 and at least one female connector 72. Each inclinable panel 20 may comprise at least one male connector 73 and at least one female connector 74. The female connector 72, 74 of a first solar panel support 1 may be configured to receive a male connector 71, 73 of a second solar panel support 1. For example, a base panel 10 of a first solar panel support 1 may comprise a female connector 72 that is configured to receive a male connector 71 of a base panel 10 of a second solar panel support 1.

As is illustrated in FIGS. 3A-3C, the at least one male connector 71, 73 and the at least one female connector 72,74 may be located at opposing lateral sides of the base panel 10 and inclinable panel 20.

As illustrated in FIGS. 3A-3C, the at least one male connector 71 of the base panel 10 is located on the first base panel side 11, the at least one female connector 72 of the base panel 10 is located on the second base panel side 12, the at least one male connector 73 of the inclinable panel 20 is located on the first inclinable panel side 21 and the at least one female connector 74 of the inclinable panel 20 is located on the second inclinable panel side 22.

The male connector 71 of a first base panel 10 may be a tang 71 (protrusion) that is configured to fit within the female connector 72 (receptacle) of an adjacent second base panel 10 to provide a rotatable joint. The male connector 71 may be inserted into the female connector 72 in an insertion direction. The insertion direction may align with an axis of the rotatable joint. Thus, the at least one male connector 71 of the first base panel 10 may be rotatably coupled to the at least one female connector 72 of an adjacent, second base panel 10.

An advantage of the rotatable joint between neighbouring panels 10,20 is that it allows undulations in the ground to which adjacent panels 10, 20 are tethered to be accommodated during ground installation, or, if the panels are floating on a body of water, allows rotational movement between adjacent panels 10, 20, to accommodate water waves on the surface of the body of water, as for example, may be generated by wind on the surface of a lake.

As shown in FIG. 3C, the male connector 71 of the base panel 10 may extend in a direction towards the hinge axis 51 of the hinge 50 that is rotatably connecting the base panel 10 to the inclinable panel 20. The male connector 73 of the inclinable panel 20 may extend in a direction towards the hinge 50 rotatably connecting the base panel 10 to the inclinable panel 20.

In at least these embodiments, the hinge 50 is configured to enable the inclinable panel 20 to lie on top of the base panel 10, such that the inclinable panel 20 overlays the base panel 10. In this configuration, a plane defined by the length and width of the inclinable panel 20 is parallel to a plane defined by the length and width of the base panel 10, i.e., in this configuration, the base panel 10 and inclinable panel 20 are aligned to be coplanar.

It may be appreciated that in some embodiments, to enable the inclinable panel to overlay the base panel, it may be desirable to disconnect the adjustment means 60 from one of the inclinable panel 20 or base panel 10. For example, it may be desirable to disconnect the adjustment means 60 at first end 61 or second end 62. In some embodiments, for example, embodiments comprising a lead screw an aperture may be provided in the inclinable panel 20, through which the adjustment means 60 may protrude, when the inclinable panel 20 overlays the base panel 10.

As the at least one male connector 71 of the base panel 10 extends parallel to the plane of the base panel 10, and the at least one male connector 73 of the inclinable panel 20 extends parallel to the plane of the inclinable panel 20, when the inclinable panel 20 overlays the base panel 10, the at least one male connector 71 of the base panel 10 is parallel to the at least one male connector 73 of the inclinable panel 20.

As the at least one male connector 71 of the base panel 10 and the at least one male connector 73 of the inclinable panel 20 both extend towards the hinge 50, when the inclinable panel 20 overlays the base panel 10, the at least one male connector 71 of the base panel 10 and the at least one male connector 73 of the inclinable panel 20 are parallel, and extend in the same direction.

Similarly, the at least one female connector 72 of the base panel and the at least one female connector 74 of the inclinable panel 20 each have an axis for receiving at least one male connector 71, 73. The axis of the female connector of the base panel 10 is in the plane of the base panel 10. The axis of the female connector of the base panel 20 is in the plane of the inclinable panel 20. Thus, when the inclinable panel 20 overlays the base panel 10, the axis of the at least one female connector 72 of the base panel 20 is parallel to the axis of the at least one female connector 74 of the inclinable panel 20.

The axis of the at least one male connectors 71, 73 and the at least one female connectors 72, 74 is parallel to the first base panel side 11, second base panel side 12, first inclinable panel side 21 and the second inclinable panel side 22.

Adjacent solar panel supports 1, each comprising a base panel 10 and an inclinable panel 20 may thus be connected by aligning the male connector 71 of the first base support 10 with the female connector 72 of the adjacent second base panel 10, and by simultaneously aligning the male connector 73 of the first inclinable panel 20 with the female connector 74 of the second inclinable panel 20. This is possible because the male connectors 71, 73 and female connectors 72, 74 are all aligned in a common direction, towards the hinge 50.

Once aligned, the male connectors 71, 73 of the first support 1 may be pushed into the female connectors 72, 74 of the adjacent second support 1 to form the coupling means 70. The male connectors 71, 73 are pushed into the female connectors 72, 74, such that the hinge axis 51 of the first support 1 and the hinge axis 51 of the second support 1 are substantially co-axial.

The fit between the male connectors 71, 73 of the first support 1 and the female connectors 72, 74 of the second support 1 may be a loose fit. Thus, in addition to permitting rotational movement of the first support 1 relative to the second support 1, about an axis aligned with the male connector 71, 73, the coupling 70 additionally permits limited rotation of the coupling 70 about an axis that is perpendicular to the axis of the male connector 71, 73. It may be appreciated that contact between the male connectors 71, 73 of the first support 1 and the female connectors 72, 74 of the second support 1 may generate a reaction force between the first support 1 and the second support 1.

The angle 63 of the first and second inclinable panels 20 may then be increased relative to the first and second base panels 10. In some, but not necessarily all embodiments, this may comprise connecting the adjustment means 60 at least one of the first end 61, second end 62.

Changing the angle 63 of the inclinable panels 20 relative to the base panels 10 correspondingly changes the direction in which the at least one male connector 71 of the base panel 10 extends relative to the direction in which the at least one male connector 73 of the inclinable panel 20 extends.

As the coupling means 70 may be disengaged by relative motion of the male connector 71 along the axis of the female connector 72 and by relative motion of the male connector 73 along the axis of the female connector 74, changing the angle 63 of the inclinable panels 20 relative to the base panels 10 therefore forms a lock between adjacent supports. Thus, adjacent panels may be quickly and simply coupled and locked together, without additionally fixings or tooling.

Although in the above example, the at least one male connector 71 of the base panel 10 and the at least one male connector 73 of the inclinable panel 20 extend towards the hinge 50, it may be appreciated that in other examples the at least one male connector 71 of the base panel 10 and the at least one male connector 73 of the inclinable panel 20 may extend away from the hinge 50.

In some but not necessarily all embodiments, the base panel 10 may not comprise at least one male connector 71, but may comprise female connectors, such as sockets, at opposing ends of the base panel. In these embodiments, female connectors 72 of neighbouring base panels 10 may be rotatably connected by aligning the sockets of the female connectors 72 of adjacent base panels 10 along a common axis and inserting a male connector pin (not shown) along the axis.

In some but not necessarily all embodiments, the coupling means 70 may additionally comprise an engagement means (not shown). The engagement means is configured to enable rotation of the rotatable joint, but to inhibit disengagement of the male connector 71 from the female connector 72, by inhibiting relative movement of the male connector 71 relative to the female connector 72 along an axis of the rotatable joint. The engagement means may comprise a pin, configured to intersect the male connector 71, 73, preventing the male connector 71 from disengaging from the female connector 72.

Alternatively, the second coupling means (not shown) may be different to the first coupling means 70. For example, in embodiments in which the coupling means 70 comprises at least one female connector 72, 74, and at least one male connector 71, 73, the second coupling means may comprise at least one female connector 72 on a first base panel 10, a second at least one female connector 72 on the adjacent second base panel 10 and a male connector, in the form of a hinge pin that is inserted into the at least one female connector 72 and the second at least one female connector 72.

It should be understood that while the FIGs illustrate a coupling means 70 that comprises male and female connectors 71-74 on both the base panel 10 and the inclinable panel 20, the solar panel support 1 may comprise a coupling means 70 located on the base panel 10 or the inclinable panel 20. For example, the solar panel support 1 may comprise the connectors 71-74 on the base panel 10.

The base panel 10 and the inclinable panel 20 may comprise a thermoplastic. For example, the base panel 10 and/or the inclinable panel 20 may comprise high density polyethylene (HDPE). The HDPE may be recycled HDPE. The base panel 10 and/or the inclinable panel 20 comprising a thermoplastic may be formed by moulding. Thus, the base panel 10 and/or the inclinable panel 20 may be lightweight. This may be desirable when installing a plurality of solar panel supports 1 as an array.

In some, but not necessarily all embodiments, the base panel 10 and/or the inclinable panel 20 may be hollow, minimising the mass of the base panel 10 and the inclinable panel 20. One or both of the base panel 10 and the inclinable panel 20 may, in this regard, comprise at least one chamber/void. The chamber/void may be gas-filled.

The chamber may be sized such that when the chamber is filled with a substance that is less dense than water (such as polystyrene, air etc.) the base panel 10 is configured to float the support on a body of water. For example, the chamber may define more than 50% of the volume of the base panel 10. The chamber may define more than 75% of the volume of the base panel 10.

The base panel 10 and/or the inclinable panel 20 may formed by blow-moulding a thermoplastic. The base panel 10 and/or inclinable panel 20 may be manufactured in this manner such that they are hollow. It should be understood that a hollow base panel 10 and/or a hollow inclinable panel 20 may be formed using other manufacturing techniques. It may be appreciated that in some embodiments, the base panel 10 and/or inclinable panel 20 may not comprise a thermoplastic, but may comprise other materials, such as wood.

The exterior surface of the base panel 10 and the inclinable panel 20 may be continuous. That is, the at least one void/chamber inside the base panel 10 and/or at least one void/chamber inside the inclinable panel 20 is sealed from an environment surrounding the support 10,20 (e.g., the void is liquid tight). This may be advantageous if the support is floating on a body of water, as water is prevented from entering the panels.

The solar panel 30 may be mechanically connected to the inclinable panel 20 by any suitable means. For example, the solar panel 30 may be clamped to the inclinable panel 20 by a frame 25, at the perimeter of the solar panel, with the frame secured to the inclinable panel 20 by mechanical fixings such as bolts, screws, rivets and/or clips secure the frame and panel 30 relative to the inclinable panel 20. Alternatively, or additionally, the solar panel 30 may be attached to the inclinable panel 20 by an adhesive.

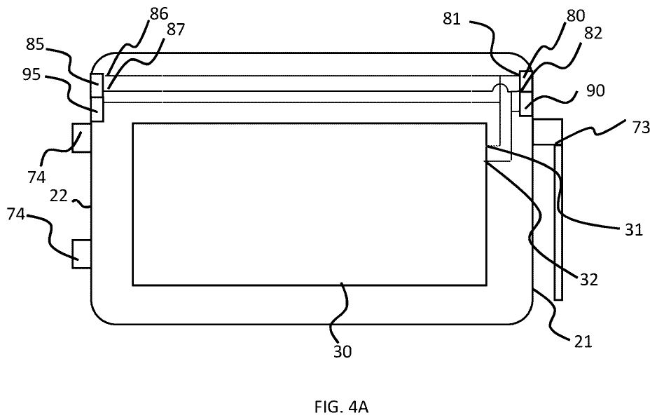

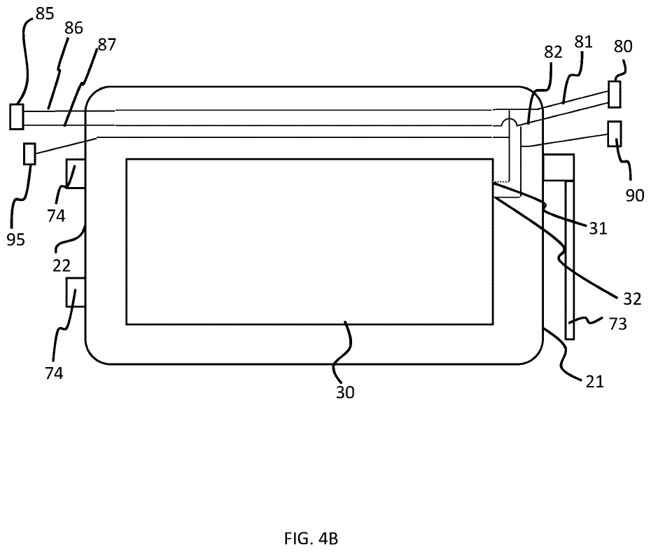

As illustrated in FIGS. 4A and 4B, each solar panel 30 comprises a positive electrical output terminal 31, and a negative electrical output terminal 32.

In FIG. 4A, the inclinable panel 20 may comprise a first twin electrical connector 80 comprising a positive port 81 and a negative port 82, and a second twin electrical connector 85, comprising a positive port 86 and a negative port 87.

The positive electrical output 31 of a solar panel 30 attached to the inclinable panel 20 may be electrically connected to the positive port 81 of the first twin electrical connector 80 and the positive port 86 of the second twin electrical connector 85. The negative electrical output terminal 31 of the solar panel 30 may be connected to the negative port 82 of the first twin electrical connector 80 and the negative port 87 of the second twin electrical connector 85.

The first twin electrical connector 80 may be proximal to the first side 21 of the inclinable panel 20. The second twin electrical connector 85 may be proximal to the second side 22 of the inclinable support 20. Once a first support 1 is coupled to an adjacent second support 1, the first twin electrical connector 80 of the first support 1 is proximal to the second twin electrical connector 85 of the adjacent support 1.

A first twin core electrical cable (not shown), may be configured to electrically connect the first twin electrical connector 80 of a first support 1 to the second twin electrical connector 85 of the adjacent second support 1. Similarly, a second twin core electrical cable (not shown), identical to the first twin-core electrical cable (not shown), may be configured to electrically connect the second support 1 to a third support 1 etc. Thus, a plurality of twin core electrical cables (not shown) may electrically connect solar panels 30 supported by supports 1 in parallel.

The inclinable panel 20 may comprise a first single electrical connector 90, and a second single electrical connector 95.

The negative electrical output 32 of the solar panel 30 may be electrically connected to the first single electrical connector 90. The positive electrical output 31 of the solar panel 30 may be electrically connected to second single electrical connector 95. Alternatively, the positive electrical output 31 of the solar panel 30 may be electrically connected to the first single electrical connector 90 and the negative electrical output 32 of the solar panel 30 may be electrically connected to second single electrical connector 95.

The first single electrical connector 90 may be proximal to the first side 21 of the inclinable panel 20. The second single electrical connector 95 may be proximal to the second side 22 of the inclinable support 20. Once a first support 1 is coupled to an adjacent second support 1, the first single electrical connector 90 of the first support 1 is proximal to the second single electrical connector 95 of the adjacent support 1.

A first single core electrical cable (not shown) may be configured to electrically connect the first single electrical connector 90 of a first support to the second single electrical connector 95 of the adjacent second support. Similarly, a second single core electrical cable, identical to the first single core electrical cable (not shown), may be configured to electrically connect the second support to a third support etc. Thus, a plurality of single core electrical cables may electrically connect solar panels supported by supports 1 in series.

The first twin electrical connector 80, second twin electrical connector 85, first single electrical socket 90, second single electrical connector 95 and electrical connections (vias) between these connectors and the positive and negative electrical terminals of the solar panel 30, therefore comprise electrical connection means to electrically connect a solar panel 30 supported by the support 1 to an electrical network. The electrical network may comprise at least part of an electrical network of a building (e.g., a residential or commercial building). The electrical network may comprise at least part of an electrical power grid (e.g., a national electrical distribution centre).

It may be appreciated that connectors 80, 85, 90, 95 may comprise either of a plug (male connection) or socket (female connection).

Solar panels 30 may be connected in either series or parallel, in dependence upon whether electrical connection is made via twin core electrical connectors 80, 85 or single core electrical connectors 90, 95.

An alternative embodiment is illustrated in FIG. 4B. The electrical connections between the solar panel 30 and the electrical connectors 80, 85, 90, 95 of FIG. 4B are as illustrated in FIG. 4B.

FIG. 4B differs from FIG. 4A in that electrical connector 80, 85, 90, 95 are not proximal to sides 21, 22 of the inclinable panel 20, but instead extend beyond sides 21,22, although remaining electrically connected to the solar panel 30 by electrical cabling. The electrical connectors 80, 95, 90, 95 extend beyond sides 21, 22 such that when adjacent supports 1 are mechanically connected, adjacent solar panels may be electrically connected by electrical connectors 80 and 85 or 90 and 95.

The electrical connectors of FIG. 4B also differ from the electrical connectors of FIG. 4A in that although the electrical connectors 80, 85, 90, 95 of FIG. 4A may be all of the same type (i.e., all plug and/or or all socket), in FIG. 4B, the electrical connectors 80, 85, 90, 95 are such that if electrical connector 80 comprises a plug, electrical connector 85 comprises a socket (and/or vice versa) and/or if electrical connector 90 comprises a plug, electrical connector 95 comprises a socket (and/or vice versa).

An advantage of this is that adjacent solar panels of adjacent supports may be directly connected to each other by the electrical plug: socket combinations of connectors 80, 85 or electrical plug socket combinations of connectors 90, 95, without additionally requiring the single core electrical cable or twin core electrical cable of the example of FIG. 4A. This eases electrical connection of solar panels 30 to an electrical network.

The solar panels 30 may output direct current. In some examples, the solar panel support 1 may comprise an electrical inverter (not shown) that is configured to convert direct current output from the solar panel 30 to alternating current. Each of the solar panel supports 1 in an array may comprise an electrical inverter. A solar panel support 1 comprising an electrical inverter provides the benefit of increased interconnectivity with devices that are only configured to receive alternating current (e.g., domestic household appliances).

At least one mechanical interlock may be provided to prevent electrical connection of a solar panel by both twin connector and single connector sockets.

The electrical cables, connections and sockets may be waterproof.

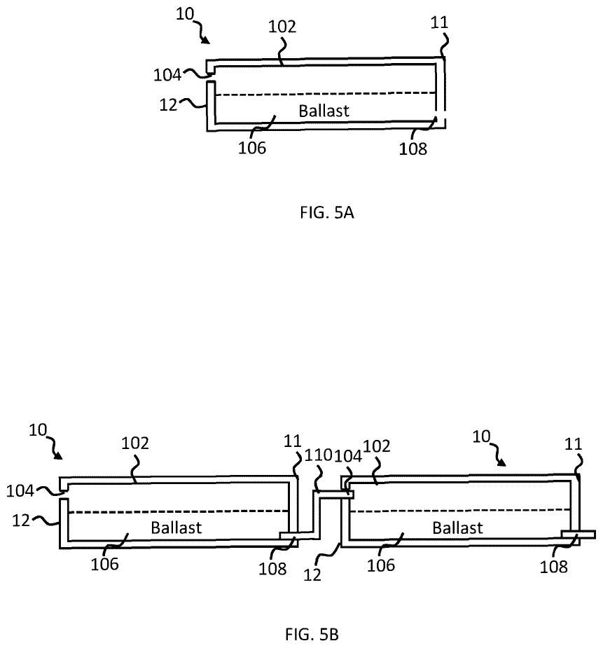

FIG. 5A illustrates a cross-sectional front view of an example of a base panel 10 of a solar panel support 1. Only the base panel 10 has been shown in FIG. 5A for clarity. The base panel 10 shown in FIG. 5A may comprise any of the features as described above and, in this regard, include a chamber 102. They also include first and second apertures 104, 108, ballast 106 and a connector 110 as described below.

As can be seen in FIG. 5A, the base panel 10 is hollow and defines a chamber 102. The chamber 102 stores ballast 106. The ballast 106 may be retained in the chamber 102 such that the stability of the solar panel support 1 is improved (particularly when the solar panel support 1 is mounted on the ground). The chamber 102 may be at least partly filled with any suitable ballast such as water, sand etc. The chamber 102 may be liquid tight such that the chamber is configured to retain a liquid ballast (e.g., water).

As shown in FIG. 5A, the support 1 comprises an aperture 104 that is configured to receive the ballast 106. The aperture 104 provides access to the chamber 102. In this example, the aperture 104 is located in the second base panel side 12 of the support 1. It should be understood that in other examples, the aperture 104 may be located at a different position on the support 1.

In the illustrated example, the aperture 104 is located towards the upper end of the second base panel side 12 such that the ballast 106 is more easily retained within the chamber 102.

The support 1 may also comprise a second aperture 108. In the illustrated example, the second aperture 108 is located towards the lower end of the first base panel side 11. The second aperture 108 is configured such that ballast 106 can be exhausted from the chamber 102. In an example in which the ballast comprises water, the chamber 102 may be at least partially filled with water via the first aperture 104 (e.g., by connecting a hose pipe to the first aperture). The chamber 102 being at least partly filled with water improves the stability of the solar panel support 1 during use. Once a user has finished using the solar panel support 1, the user may exhaust the water from the chamber 102 by opening the aperture 108 and allowing the water to exhaust from the chamber 102. Once the water has exhausted from the chamber 102, the weight of the solar panel support 1 is significantly reduced such that a user can move the solar panel support 1 with reduced effort.

The solar panel support 1 may comprise at least one plug/cap for plugging one or more of the apertures 104, 108 such that the ballast is retained within the chamber 102.

FIG. 5B illustrates a cross-sectional front view of an example of a pair of base panels 10 of the solar panel support 1.

FIG. 5B differs from FIG. 5A in that FIG. 5B shows a second base panel 10 on the right hand side that comprises the same features as the base panel 10 shown in FIG. 5A (e.g., the chamber 102, apertures 104, 108 and ballast 106 as described above). The base panels 10 may be connected by a connector 110. The connector 110 connects the second aperture 108 of the left base panel 10 to the first aperture 104 of the right base panel 10. The connector 110 is configured such that ballast 106 retained in one of the chambers 102 of the base panels 10 may be transported to the chamber 102 of the other connected base panel 10 via the connector 110. For example, a user may connect a water source (e.g., a hose pipe) to the first aperture 104 of the left base panel 10. As the chamber 102 receives the water, the water is also distributed to the right base panel 10 via the connector 110. This enables both chambers 102 to be filled while only having to connect a water source to a single base panel 10 (i.e., rather than have to connect and disconnect the right/second base panel 10 to a water source separately). This can be particularly time and labour intensive in examples where there are large numbers of solar panel supports 1 in an array. It should be understood that any number of base panels 10 can be connected (i.e., daisy-chained together) as shown in FIG. 5B.

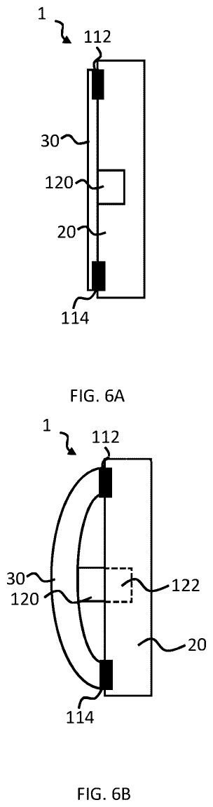

FIG. 6A illustrates a plan view of an example of the solar panel support 1 in a first configuration and FIG. 6B illustrates a plan view of an example of the solar panel support 1 in a second configuration. Components such as the base panels 10 have not been shown in FIGS. 6A and 6B for clarity. The inclinable panels 20 shown in FIGS. 6A and 6B may comprise any of the features as described above and may differ from those inclinable panels 20 as described below.

The solar panel 30 supported by the solar panel support 1 illustrated in FIGS. 6A and 6B is a deformable solar panel 30 (i.e., such that it can be bent or deformed to form an arc). The solar panel 30 is fastened to the inclinable panel 20 by one or more fasteners 112, 114. The fasteners 112, 114 may be one or more of an adhesive, screw(s), bolt(s), or a rail system.

The solar panel support 1 comprises an actuator 120. The actuator 120 may be any suitable type of actuator for causing the solar panel support 1 to transition between the first configuration and the second configuration. The actuator 120 may be a linear actuator. The actuator 120 may be a hydraulic, pneumatic or electric actuator.

In the first configuration as shown in FIG. 6A, the receiving surface of the solar panel 30 is substantially flat. The actuator 120 may cause the solar panel support 1 to transition into the second configuration. FIG. 6B shows that the actuator 120 has caused at least a portion of the solar panel 30 to move away from the inclinable panel 20 such that the light receiving surface of the solar panel 30 is substantially arcuate in shape or substantially bent. In the second configuration, the shape of the solar panel 30 provides greater exposure to the sun's azimuth than the shape of the solar panel 30 in the first configuration. During testing, the inventor has found that the shape of the solar panel 30 in the second configuration provides 15% more power than the shape of the solar panel 30 in the first configuration. The inventor has also found that the combined effect of inclining the solar panel 30 to compensate for the angle of the sun above the horizon in combination with the solar panel 30 being in the second configuration increases the output of the solar panel by around 30%.

The actuator 120 may cause at least a portion of the solar panel 30 to move by pushing at least a portion of the solar panel 30, such that the solar panel support 1 transitions from the first configuration to the second configuration. The actuator 120 may cause the solar panel support 1 to transition from the second configuration to the first configuration by pulling at least a portion of the solar panel 30.

It should be understood that whilst FIGS. 6A and 6B show that the actuator 120 is in directly connected to the solar panel 30, it should be understood that any number of intervening components may be present between the actuator 120 and the solar panel 30 (i.e., such that the actuator 120 and the solar panel 30 are indirectly connected).

The solar panel 30 may be at least partly fastened to the inclinable panel 20 by at least one fastener 112, 114 at or close to the periphery of the inclinable panel 20. The at least one fastener 112, 114 and the actuator 120 may be configured such that, when the actuator 120 causes the solar panel support 1 to transition between the first configuration and the second configuration, the solar film 30 remains fastened to the inclinable panel 20 at or close to the periphery of the inclinable panel 20. The periphery of the inclinable panel 20 may be parts of the inclinable panel 20 that are closer to the sides 21, 22 than the centre of the inclinable panel 20.

It will be appreciated that various changes and modifications can be made to the present invention without departing from the scope of the present application.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A solar panel support, comprising:
a hollow base panel;
an inclinable panel,
wherein the inclinable panel is:
inclinable at an angle to the base panel,
configured to be attached to the solar panel, and
provided with coupling means configured to couple the inclinable panel of the solar panel support to an inclinable panel of an adjacent solar panel support;
wherein the base panel and the inclinable panel are rotatably connected by at least one hinge.

2. The solar panel support as claimed in claim 1, wherein:
the coupling means comprises:
a male connector and a female connector sized for insertion of a male connector within a female connector in an insertion direction, wherein the male connector and the female connector are at opposing lateral sides of the inclinable panel and the insertion directions are substantially orthogonal to the at least one hinge; and
the base panel comprises a male connector and a female connector sized for insertion of a male connector with a female connector in an insertion direction, wherein the male connector and the female connector are at opposing lateral sides of the base panel and the insertion directions are substantially orthogonal to the at least one hinge.

3. The solar panel support as claimed in claim 2, wherein:
the female connector of the base panel is configured to receive a male connector of a second base panel of a second solar panel support; and
the female connector of the inclinable panel is configured to receive a male connector of a second inclinable panel of a second support.

4. The solar panel support as claimed in claim 1, wherein the base panel comprises at least one tether attachment.

5. The solar panel support as claimed in claim 1, wherein the base panel comprises at least one gas-filled void.

6. (canceled)

7. The solar panel support as claimed in claim 1, wherein the base panel and the inclinable panel are substantially cuboidal.

8. The solar panel support as claimed in claim 1, wherein the inclinable panel comprises at least one electrical connector to electrically connect the solar panel supported by the solar panel support to an electrical network.

9. (canceled)

10. The solar panel support as claimed in claim 8, wherein the inclinable panel comprises an electrical inverter configured to convert direct current output from the solar panel to alternating current.

11. The solar panel support as claimed in claim 1, wherein the hollow base panel defines at least one chamber that is configured to receive and retain ballast.

12. The solar panel support as claimed in claim 11, wherein the chamber comprises an aperture that is configured to receive the ballast.

13-14. (canceled)

15. The solar panel support as claimed in claim 114, wherein the chamber comprises at least one aperture configured to exhaust the ballast from the chamber.

16. The solar panel support as claimed in claim 15, wherein the chamber comprises an aperture that is configured to receive the ballast and the aperture configured to receive the ballast is different from the aperture configured to exhaust the ballast from the chamber.

17. The solar panel support as claimed in claim 15, further comprising a connector configured to connect the at least one aperture configured to exhaust the fluid from the chamber to an aperture in the base panel of a second solar panel support.

18. The solar panel support as claimed in claim 1, wherein the solar panel supported by the solar panel support is a solar film and the solar panel support is configured to provide a first configuration in which a light receiving surface of the solar film is substantially flat and a second configuration in which the light receiving surface of the solar film is substantially arcuate or substantially bent.

19. The solar panel support as claimed in claim 18, wherein the inclinable panel comprises an actuator configured to cause the solar panel support to transition between the first and second configurations.

20. The solar panel support as claimed in claim 19, wherein the solar film is at least partly fastened to the inclinable panel by at least one fastener at or close to the periphery of the inclinable panel, and the at least one fastener and the actuator are configured such that, when the actuator causes the solar panel support to transition between the first configuration and the second configuration, the solar film remains fastened to the inclinable panel at or close to the periphery of the inclinable panel.

21. The solar panel support as claimed in claim 19, wherein the actuator is configured to push a portion of the solar film to transition the solar panel support to transition from the first configuration and the second configurations.

22. A system, comprising the solar panel support as claimed in claim 2, wherein the solar panel support is a first solar panel support connected to a second solar panel support, and the second solar panel support comprises:
a hollow base panel;
an inclinable panel,
wherein the inclinable panel is:
inclinable at an angle to the base panel,
configured to be attached to the solar panel, and
provided with coupling means configured to couple the inclinable panel of the solar panel support to an inclinable panel of an adjacent solar panel support;
wherein the base panel and the inclinable panel are rotatably connected by at least one hinge, wherein the coupling means comprises a male connector and a female connector sized for insertion of a male connector within a female connector in an insertion direction, wherein the male connector and the female connector are at opposing lateral sides of the inclinable panel and the insertion directions are substantially orthogonal to the at least one hinge; and
the base panel comprises a male connector and a female connector sized for insertion of a male connector with a female connector in an insertion direction, wherein the male connector and the female connector are at opposing lateral sides of the base panel and the insertion directions are substantially orthogonal to the at least one hinge.

23. A method for locking adjacent solar panel supports, the method comprising:
aligning a base panel and an inclinable panel of a first solar panel support to be coplanar;
aligning a base panel and an inclinable panel of a second solar panel support to be coplanar;
receiving a male connector of the base panel of the first solar panel support within a female connector of the base panel of the second solar panel support and receiving a male connector of the inclinable panel of the first solar panel support within a female connector of the inclinable panel of the second solar panel support; and
inclining the inclinable panels of the first and second solar panel supports to the base panels of the first and second solar panel supports.

24-34. (canceled)

35. A solar panel support, comprising:
a hollow base panel;
an inclinable panel,
wherein the inclinable panel is:
inclinable at an angle to the base panel,
configured to be attached to the solar panel, and
provided with at least one connector configured to couple the inclinable panel of the solar panel support to an inclinable panel of an adjacent solar panel support;
wherein the base panel and the inclinable panel are rotatably connected by at least one hinge.
